(19) United States
(12) Patent Application Publication
(10) Pub. No.: US 2014/0284938 A1
(43) Pub. Date: Sep. 25, 2014

(54) GRAVITATIONAL ENERGY CONVERSION DEVICE AND APPLICATION THEREOF

(71) Applicant: Yuliang Xu, Jiaxing (CN)

(72) Inventor: Yuliang Xu, Jiaxing (CN)

(21) Appl. No.: 14/352,338

(22) PCT Filed: Jul. 16, 2012
(86) PCT No.: PCT/CN2012/078723

§ 371 Date: Apr. 17, 2014

(30) Foreign Application Priority Data
Oct. 26, 2011 (CN) 2011103726416

(51) Int. Cl. H02K 7/18

(52) U.S. Cl. CPC H02K 7/1807; Y10S 74/09; F03G 7/10
USPC 290/1 R; 74/DIG. 9

(57) ABSTRACT

The invention discloses a gravitational energy conversion device, comprises a device frame, a weight, a luggage carrier, a combined spring, a chain, a ratchet wheels, a transmission shaft, flywheels, a limit latch, and a return spring. The transmission shaft is arranged on the device frame. The flywheels are arranged at both ends of the transmission shaft. The ratchet wheels are arranged on the transmission shaft. The ratchet wheels engage with the chain. One end of the chain is fixed to the limit latch, and the other end is connected to one end of the combined spring. Pairs of pawls which match the limit latch are arranged on inner sidewalls of the device frame in the same horizontal plane. One end of the return spring is fixed to the limit latch, and the other end is fixed to the luggage carrier.

### CROSS-REFERENCE TO RELATED APPLICATION

This application is the U.S. national phase of International Application No. PCT/CN2012/078723, filed on Jul. 16, 2012, which claims the priority benefit a Chinese Patent which is application No. 2011103726416 filed on Oct. 26, 2011. the entire contents of which is hereby incorporated by reference.

### BACKGROUND OF THE INVENTION

1. Field of the Invention

The present invention relates to an energy utilization device, and in particular to a gravitational energy conversion device which converts energy in a vibration of the combination of an object (under the action of gravitation/gravity) and an elastic element into mechanical energy, hydraulic energy, or pressure energy for later use.

2. Background of Invention

The energy issue, especially the use and development of green energy (such as wind, solar and tidal energy or the like) is currently not only prominent, but also difficult in terms of technical view. Among these, the wind and solar energy has been put into application to a certain extent, and solar water heaters have been widely accepted in people's daily lives. However, as the most stable, fair, and environmental-friendly energy, the gravitational energy is discriminated as a witchcraft and technology utopia, and is even prevented from applying for an application. Fortunately, colleagues now start to justify the gravitational energy (see speech made by Xu Yuhui on June 7, 2011 in Chongqing University, who is a professor from Tamkang University of Taiwan). It is believed that changes in idea will bring about change in the world.

Force produced by relative rotation between the Earth and other celestial bodies is called gravity. For centuries, there is little understanding of the nature of gravity, but this does not hinder people's interest and research on it.

In CN87106130, it is disclosed a vibration energy conversion device, a bowl-shaped rod and a spherical rod are added to a damping spring of a transport vehicle, and are connected to a frame or shaft of the vehicle. The vibration energy of the frame with respect to the shaft is converted into electricity, liquid pressure energy, and gas pressure energy for providing power to the vehicle. The vibration energy conversion device replaces energy devices in the existing transportation vehicles powered by fuel or electricity. In the device, elastic potential energy of the spring is converted into other forms of energy through the bowl-shaped rod and the spherical rod.

In CN200810031082.0, it is disclosed an environmental-friendly engine, comprising an environmental-friendly energy resource generating system and an engine system. The environmental-friendly energy resource generating system is connected with the engine system through a pipe. The environmental-friendly energy resource generating system comprises an inertial block, a resonance spring, and an oil pump or air compressor. In the engine, mechanical movement produces vibration energy, which drives the oil pump and is converted into hydraulic energy, or which drives the air compressor and is converted into pressure energy. In this way, the engine is driven. However, the problem of energy conversion in fluctuation objects still exists.

In CN201010165824.6, it is disclosed a terrestrial gravity generator, comprising a power mechanism connected with a generator. The power mechanism comprises an uprightly arranged chain wheel and chain mechanism and a plurality of heavy punch members arranged on the chain wheel and chain mechanism. The chain wheel and chain mechanism mainly comprises a chain and two chain wheels, the left sides and the right sides of the central lines of the two chain wheels are divided into descent stages and ascent stages, and the force arms from the heavy punch members of the descent stages to the chain are longer than the force arms from the heavy punch members of the ascent stages to the chain, thus developing rotation for driving the generator to generate electricity.

In CN200680002157.1, it is disclosed a gravitation rail or gravitation road for generating electricity with gravity. The gravitation rail or gravitation road is high at one end and low at the other end, develops from a high slope to a low slope, transits from the low slope to another high slope, and then develops from the high slope to a low slope again. The high slope and low slope are repeated in such a manner that a circular or straight gravity rail is formed for generating electricity with gravity.

Nowadays, the existing systems for exploiting gravitational energy is complicated, high in cost, low in efficiency, and thus is difficult for large-scale commercial operation.

### BRIEF SUMMARY OF THE INVENTION

It is an object of the present invention to provide an energy conversion device, which converts gravitational energy into mechanical energy, hydraulic energy, or pressure energy during vibration. The energy conversion device can be applied to a factory power station, a workshop power station, or a home power station. Thus, an electric tower, wiring, and power substation can be omitted.

It is another object of the present invention to provide an energy conversion device, which cooperates with various transmission parts and can be applied as a motor or generator in sailing ships, driving cars, and flying airplanes. It can provide a most environmental, ideal, and convenient mobile power station.

A gravitational energy conversion device comprises a device frame, a weight, a luggage carrier, a combined spring, a chain, a ratchet wheels, a transmission shaft, flywheels, a limit latch, and a return spring. The transmission shaft is arranged on the device frame. Flywheels are arranged at both ends of the transmission shaft. One or more of ratchet wheels are arranged in parallel on the transmission shaft. One chain is arranged on each of the ratchet wheels. One end of the chain is fixed to the limit latch, and the other end is connected to one end of the combined spring Pairs of pawls which match the limit latch are arranged on inner sidewalls of the device frame in the same horizontal plane. One end of the return spring is fixed to the limit latch, and the other end is fixed to the luggage carrier. The other end of the combined spring is connected with the luggage. A steel spring plate is arranged on the luggage carrier, and the weight is fixed to the steel spring plate. An energy feedback device is connected below the luggage carrier with a steel cable. The energy feedback device can comprise an electric motor, an oil motor, an air motor, or an electromagnetic magnet coil, and outputs energy under control of an electronic control component for maintaining the continuous sinusoidal vibration of the weight and the elastic element. As used herein, the elastic element refers to the combined spring and the steel spring plate. In vibration in which gravitational energy of the weight plays a dominant role, the elastic element continuously produces a weightless state and an overweight state, and is referred to as a vibrator here. When the weight in the vibrator is subject to elastic potential energy and restores upward to a position over a static weighing position, the weight is in a weightless state. At this time, the return spring and the steel spring plate start to operate until the weight restores to a position with a high level of potential energy. When the weight drops from the position with a high level of potential energy, the counterforce by which the weight stretches the spring drives the chain, and ratchet wheels are driven to rotate flywheels for outputting mechanical energy. When gravitational energy is converted into mechanical energy, potential energy of the spring is also accumulated for restoring the weight to the position with a high level of potential energy. 80-90% of the energy can be accumulated, which depends on quality of the spring. As a result, the feedback device can spend only 20% of the energy for maintaining the vibrator to vibrate in a sinusoidal mode continuously. Thus, gravitational energy can be converted constantly into mechanical energy, hydraulic energy, or pressure energy which can be applied to a motor or generator and to production and life.

The technical solution of the present invention has the following beneficial effects. As disclosed in the present invention, the energy conversion device utilizes gravitational energy of the elastic element and the weight by means of the energy feedback device, and establishes a vibrator which vibrates continuously with constant amplitude. During vibration, the gravitational energy is converted into mechanical energy by means of mechanical elements, into hydraulic energy by means of hydraulic elements, and into pressure energy by pneumatic elements. Along with transmission parts, the device of the present invention can be applied as a motor and generator for replacing the existing internal combustion engines, gas turbines, coal combustion engines, so that the Earth can have a chance to rest and recover. The device of the present invention has a simple structure, a low manufacturing cost, a small footprint, and a high efficiency. Besides, the present device has a good adaptability with respect to the energy sources, and can be applied in any place with gravity, e.g. can be applied on the sea, on the land and in the air.

### BRIEF DESCRIPTION OF THE DRAWINGS

FIG. 1 is a schematic view illustrating the structure of an energy conversion device according to an embodiment of the present invention;

FIG. 2 is a side view illustrating the structure of the energy conversion device of the present invention shown in FIG. 1;

FIG. 3 is an enlarged view illustrating the portion A in the energy conversion device of the present invention shown in FIG. 2; and

FIG. 4 is a simplified view illustrating the principle of a vibrator in the energy conversion device of the present invention.

### DETAILED DESCRIPTION OF THE EMBODIMENTS

The technical solution of the present invention will be described in detail hereinafter by referring to the accompanying drawings.

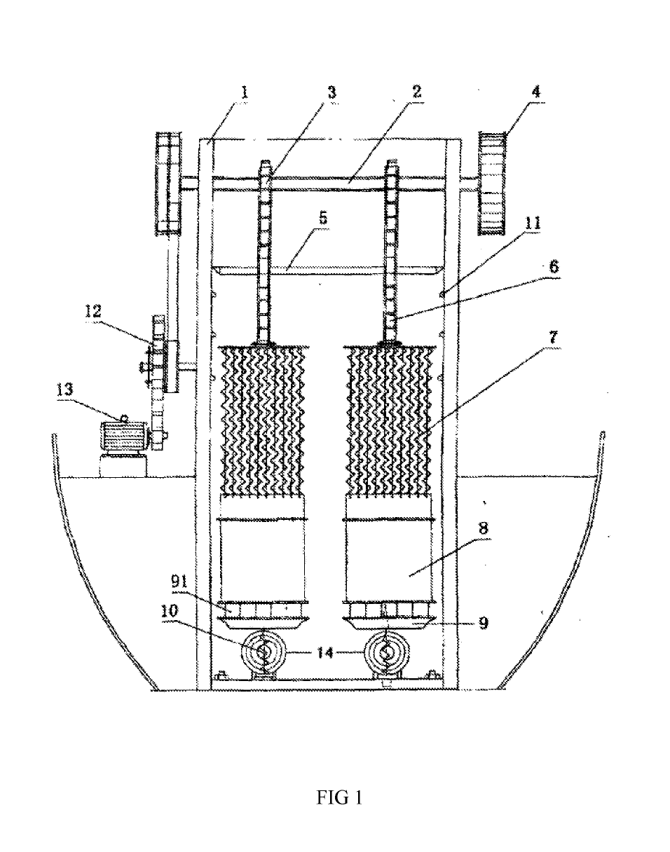

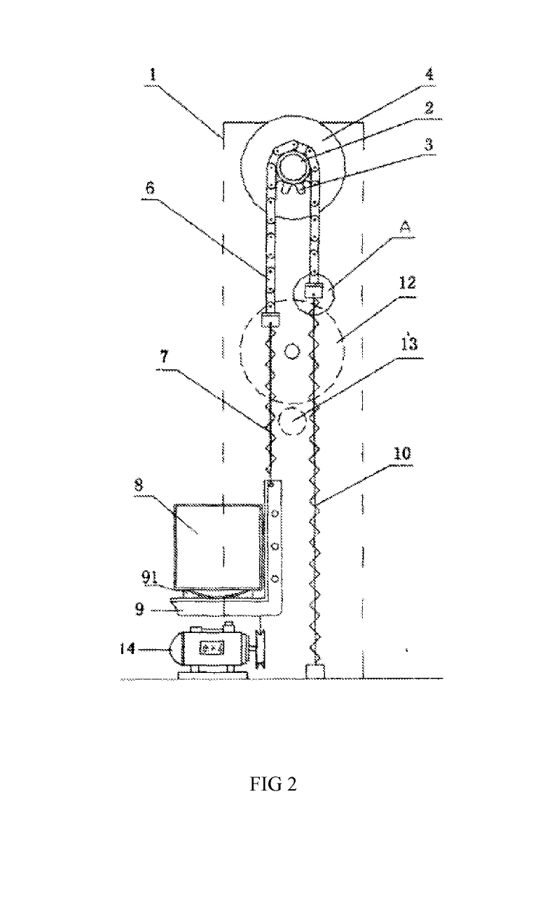

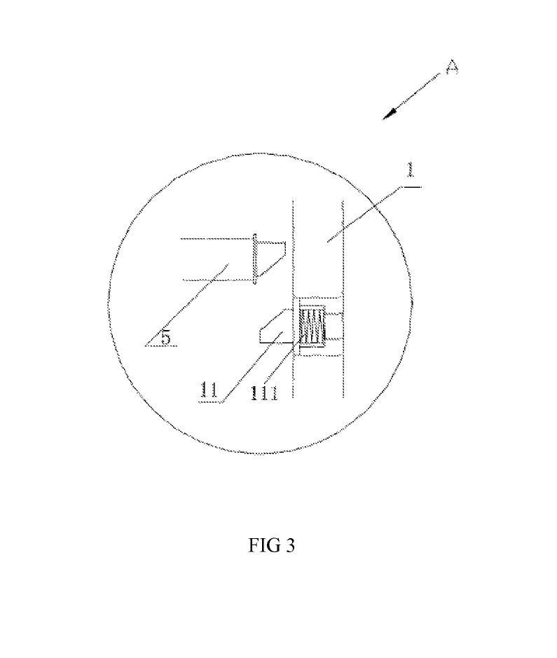

As shown in FIGS. 1, 2, and 3, an energy conversion device of the present invention comprises a device frame 1, a transmission shaft 2, ratchet wheels 3, flywheels 4, a limit latch 5, a chain 6, a combined spring 7, a weight 8, a luggage carrier 9, a return spring 10, and an energy feedback device 14.

The transmission shaft 2 is arranged on the device frame 1. Flywheels 4 are arranged at both ends of the transmission shaft 2. One or more of ratchet wheels 3 are arranged in parallel on the transmission shaft 2. The chain 6 is arranged on each of the ratchet wheels 3. One end of the chain 6 is fixed to the limit latch 5, and the other end is connected to one end of the combined spring 7. Three pairs of pawls 11 which match the limit latch are arranged on inner sidewalls of the device frame 1 in the same horizontal plane. Springs 111 are arranged between the pawls 11 and the device frame 1 for expanding and contracting the pawls 11. One end of the return spring 40 is fixed to the limit latch 5, and the other end is fixed to luggage carrier 9. The other end of the combined spring 7 is connected with the luggage carrier 9. A steel spring plate 91 is arranged on the luggage carrier 9. The weight 8 is fixed to the steel spring plate 91. The feedback device 14 is arranged below the luggage carrier 9 and is connected with the luggage carrier 9 with a steel rope.

When the device of the present invention is installed in a ship or workshop, the feedback device 14 is drove by an external energy to pull the steel rope, so that the luggage carrier 9 and the weight 8 move downward. Meanwhile, the combined spring 7 is stretched. The feedback device 14 is shut down when it is not subject to any force.

At this time, the combined spring 7 tends to restore. When the combined spring 7 drives the weight 8 towards the weightless region, the weight 8 is locked by a pair of pawls 11. In this case, the external energy is started again to drive the feedback device to repeat the above actions until the weight 8 is locked by pawls 11 to a position with the highest level of potential energy. Then, the feedback device is switched to a generator 13 in the present device. The spring 111 is also started, so that potential energy of the weight 8 is released, thus pulling the combined spring 7 and driving ratchet wheels 3 to rotate the transmission shaft 2 and flywheels 4. In case flywheels 4 are provided with a gearbox 12 and the generator 13, the rotating flywheels 4 drive the gearbox 12, and drive the generator 13 to generate electricity due to the conversion of gravitational energy into mechanical energy. From now on, the feedback device makes use of the electricity generated by the present device, feedbacks the electricity to a vibrator comprising the steel spring plate 91 of the combined spring 7 and the weight 8 according to instructions from an electronic control component, and supplies energy for maintaining the vibrator's continuous vibration with constant amplitude. When the potential energy is released, the combined spring 7 and the return spring 10 are stretched and the steel spring plate 91 is compressed at the same time. 80-90% of energy for restoring the weight 8 to its position with the highest level of potential energy is accumulated in these three items. As a result, the energy which is required to be feedback for the vibrator to vibrate in a sinusoidal mode for a cycle is smaller than 20% of the generated electricity. Thus, the present device can constantly convert gravitational energy into mechanical energy.

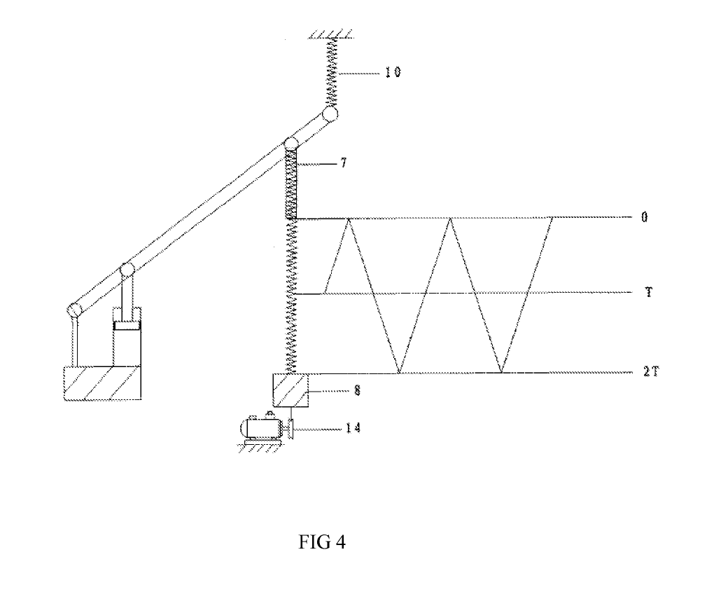

FIG. 4 is a simplified view showing the vibrator which comprises the weight 8, the combined spring 7, the feedback device 14, and the return spring 10 in the present device. 0 indicates a weightless position of weight 8, T indicates a static weighing position of the weight 8, and 2T indicates an overweight position of the weight 8. In this way, the weightless and overweight states produced by the continuous vibration with constant amplitude are the most appropriate moment for establishing a hydraulic energy station or pressure energy station.

1. A gravitational energy conversion device, characterized by comprising a device frame, a weight, a luggage carrier, a combined spring, a chain, a ratchet wheels, a transmission shaft, flywheels, a limit latch, and a return spring;
wherein pairs of pawls are arranged on inner sidewalls of the device frame in the same horizontal plane, and the pairs of pawls match the limit latch;
wherein a steel spring plate is arranged on the luggage carrier, and an energy feedback device is arranged below the luggage carrier, the energy feedback device can be an oil motor, an air motor, an electric motor, or an electromagnetic magnet coil, and the energy feedback device can operate under control of an electronic control component, so that it feedbacks energy to maintain continuous vibration of the weight and the combined spring;
wherein the transmission shaft is arranged on the device frame, the flywheels are arranged at both ends of the transmission shaft, one or more of the ratchet wheels are arranged in parallel on the transmission shaft, the chain is arranged on each of the ratchet wheels, one end of the chain is fixed to the limit latch, and the other end is connected to one end of the combined spring, the other end of the combined spring is connected with the luggage, one end of the return spring is fixed to the limit latch, and the other end is fixed to the luggage carrier, and the weight is fixed to the steel spring plate.

2. The gravitational energy conversion device of claim 1, characterized in that, the energy feedback device enables the weight and the combined elastic element to continuously vibrate in a sinusoidal mode with constant amplitude under domination of the gravitational energy of the weight, so that the weight and the combined elastic element act as a vibrator that continuously alternates between a weightless state and an overweight state, wherein in the weightless state, the return spring and the steel spring plate operate in such a manner that the potential energy of the weight returns to a high level, and in the overweight state, a counterforce by which the gravitational energy of the weight pulls the spring acts on the chain for driving the ratchet wheels and thus driving the flywheels, and the gravitational energy is converted into mechanical energy which is output and can be applied to a motor or generator.

3. The gravitational energy conversion device of claim 1, characterized in that, the weightless state and the overweight state formed by the vibrator comprising the weight and the elastic element are applied to a hydro cylinder by means of a lever, wherein in the weightless state, a piston rises to inhale a hydraulic oil, and in the overweight state, a high pressure oil is pressed out and stored in an energy accumulator for creating a high energy hydraulic station that can be directly applied to industrial production, and the hydraulic energy can also be applied to a motor or generator.

4. The gravitational energy conversion device of claim 1, characterized in that, the weightless state and the overweight state formed by the vibrator comprising the weight and the elastic element are applied to a pneumatic cylinder by means of a lever, wherein in the weightless state, a piston rises to inhale air, and in the overweight state, a compressed air enters an energy accumulator for creating a high energy pressure station which can be applied to production and life, and the pressure energy can also be applied to a motor or generator.
